(19) United States
(12) Patent Application Publication
(10) Pub. No.: US 2024/0413696 A1
(43) Pub. Date: Dec. 12, 2024

(54) WINDING HEAD HOLDER OF A ROTOR FOR AN ELECTRIC MACHINE

(71) Applicant: Voith Patent GmbH, Heidenheim (DE)

(72) Inventors: Michael Weckert, Aalen (DE); Bernd Heinrich, Oellingen (DE); Stefan Veser, Böhmenkirch-Treffelhausen (DE); Philipp Eilebrecht, Heidenheim (DE)

(73) Assignee: Voith Patent GmbH, Heidenheim (DE)

(21) Appl. No.: 18/809,898

(22) Filed: Aug. 20, 2024

Related U.S. Application Data
(63) Continuation of application No. PCT/EP2023/052485, filed on Feb. 2, 2023.

(30) Foreign Application Priority Data
Feb. 21, 2022 (DE) 10 2022 104 000.3

(51) Int. Cl. H02K 3/51

(52) U.S. Cl. CPC H02K 3/51

(57) ABSTRACT

A rotor for an electric machine includes a rotor body, winding elements, and a winding head arranged axially adjacent to the rotor body, and wherein the winding head encompasses two regions, wherein in a first region the winding elements progress in axial direction, and wherein in a second region the winding elements progress at an angle to the axial direction, and wherein each winding element in the second region in which it progresses at an angle to the axial direction is located at a distance of A₁ from a first directly adjacent winding element of the same layer and at a distance A₂ from a second directly adjacent winding element of the same layer, wherein A₂ is greater than A₁.

### CROSS REFERENCE TO RELATED APPLICATIONS

This is a continuation of PCT application no. PCT/EP2023/052495, entitled “WINDING HEAD HOLDER OF A ROTOR FOR AN ELECTRIC MACHINE”, filed Feb. 2, 2023, which is incorporated herein by reference. PCT application no. PCT/EP2023/052495 claims priority to German patent application no. 10 2022 104 000.3, filed Feb. 21, 2022, which is incorporated herein by reference.

### BACKGROUND OF THE INVENTION

### 1. Field of the Invention

The present invention relates to a rotor for an electric machine.

### 2. Description of the Related Art

DE 10 2010 020 415 A1 discloses a rotor that is suitable for a variable-speed hydroelectric power motor-generator. The rotor disclosed in this document includes winding elements which are arranged in two layers in axial grooves of a rotor body, a winding head which is arranged axially adjacent to the rotor body, and a winding head support, wherein the winding head is connected to the winding head support by way of tension bolts. The tension bolts engage at their radial outer ends with support bodies, which in turn rest on the winding elements of the outer layer in the region of the winding head. Each winding element is thus held by two tension bolts by way of one support body per tension bolt in the region of a winding head. The support bodies and the associated tension bolts are arranged in two rings per winding head, whereby each ring is arranged in a plane perpendicular to the rotor axis. The planes are located in the areas where the winding elements follow an axially oriented progression.

DE 10 2018 124 011 B3 discloses a comparable rotor. Per winding head, the support bodies and the associated tension bolts are arranged in three rings, wherein each ring is arranged in a plane perpendicular to the rotor axis. The planes are located in the areas where the winding elements follow an axially oriented progression. Therefore, the winding elements have a complicated curved progression in the region of the winding head, which requires a total of four curvature areas per winding element per winding head.

DE 195 13 457 A1 discloses a comparable rotor. For each winding head, the support bodies and the associated tension bolts are arranged in a multitude of rings, wherein each ring is arranged in a plane perpendicular to the rotor axis.

One of the planes is positioned in a region where the winding elements present an axially oriented progression. The other planes are in a region where the winding elements progress at an angle relative to the axial direction.

What is needed in the art is a rotor having an alternative structure and which is characterized by increased rigidity and is easier to mount.

### SUMMARY OF THE INVENTION

The present invention relates to a rotor for an electric machine, in particular for a rotor-driven slip ring rotor machine, as are being used for variable speed hydroelectric power motor-generators for pumped storage power stations.

The present invention provides a rotor for an electric machine, the rotor including a rotor body, a plurality of winding elements, and a winding head arranged axially adjacent to the rotor body, wherein the winding elements are arranged in two layers in axially progressing grooves of the rotor body, and wherein the winding head encompasses two regions, wherein, in a first region, the winding elements progress in axial direction, and wherein, in a second region, the winding elements progress at an angle to the axial direction, and wherein the winding head includes a winding head support and a plurality of retaining elements, and wherein each retaining element respectively includes a tension bolt and a support body, and wherein the support body is arranged at least partially in radial direction outside of the winding elements, and wherein the tension bolts respectively penetrate an associated support body and are screwed into the winding head support by way of a thread, and wherein at least a part of the tension bolts penetrates the winding head in radial direction in the second region, characterized in that, each winding element in the second region in which it progresses at an angle to the axial direction is located at a distance of A₁ from a first directly adjacent winding element of the same layer and at a distance A₂ from a second directly adjacent winding element of the same layer, wherein A₂ is greater than A₁.

Optionally, half of the winding elements form a first group, and wherein the other half of the winding elements form a second group, and wherein the winding elements of the first group protrude by a length of L₁ from rotor body in axial direction before they progress at an angle to the axial direction, and wherein the winding elements of the second group protrude by a length of L₂ from rotor body in axial direction before they progress at an angle to the axial direction, and wherein L₁ is greater than L₂.

Optionally, half of the winding elements form a first group, and wherein the other half of the winding elements form a second group, and wherein the winding elements of the first group have a radius of curvature R₁ at which they turn from the axial direction to the direction progressing at an angle to the axis after emergence from rotor body, and wherein the winding elements of the second group have a radius of curvature R₂ at which they turn from the axial direction to the direction progressing at an angle to the axis after emergence from the rotor body, and wherein R₁ is greater than R₂.

Optionally, with respect to one layer, winding elements of the first group and winding elements of the second group differ in design.

Optionally, with respect to one layer, the winding elements of the first group and the winding elements of the second group do not differ in design.

Optionally, the retaining elements (5) respectively include a stop surface, which is designed in such a way that it can come into contact with the winding head support when screwing in the tension bolts, in order to thereby adjust the radial length with which the tension bolts protrude from the winding head support to a predefined dimension, wherein the predefined dimension is calculated so that the support bodies are not pressed against the winding elements in a resting position of rotor.

Optionally, a respective retaining element includes an elastic element which is arranged in the space between associated support body and winding elements which are held by the respective retaining element.

Optionally, a stop surface is formed by a step of the tension bolt.

Optionally, a retaining element includes a sleeve, and wherein the tension bolt penetrates the sleeve, and wherein the stop surface is formed by the end of the sleeve, which is oriented towards the winding head support.

Optionally, the tension bolt includes a step which can be pressed against the sleeve when the tension bolt is tightened.

Optionally, a respective support body includes a sleeve-like protuberance, and wherein the stop surface is arranged at the end of the protuberance.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a rotor according to the state of the art;

FIG. 2 shows two embodiments of rotors according to the invention;

FIG. 3 shows an additional embodiment of a rotor according to the invention;

FIG. 4 shows an additional embodiment of a rotor according to the invention;

FIG. 5 shows an additional embodiment of a rotor according to the invention;

FIG. 6 shows embodiments of the retaining elements according to the invention; and

FIG. 7 shows a rotor according to the invention with illustration of the retaining elements.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

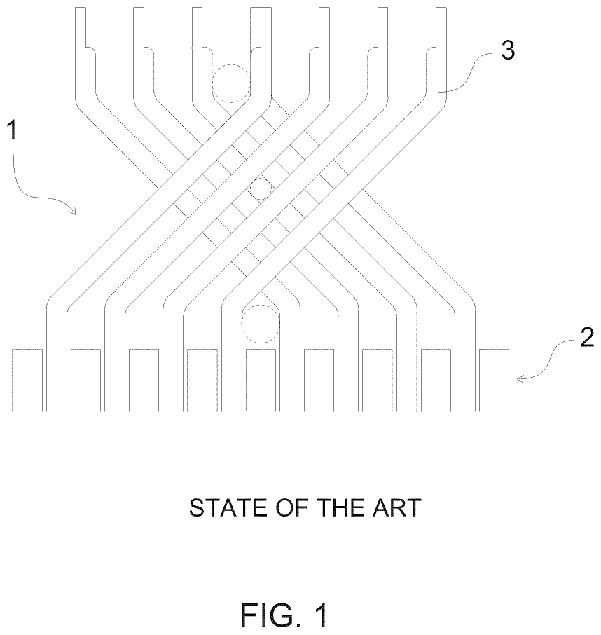

FIG. 1 illustrates a rotor according to DE 195 13 457 A1. FIG. 1 is a simplified representation of the winding head of the rotor. The rotor is labeled 1. Rotor 1 includes a rotor body which is labeled 2. Rotor 1 includes winding elements which are arranged in two layers in axially progressing grooves of rotor body 2. The winding head includes two regions, wherein the winding elements progress in axial direction in a first region, and wherein—in a second region—the winding elements progress at an angle relative to the axial direction. One of the winding elements of the outer layer is labeled 3. The dashed circles in FIG. 1 indicate the space that is available at various points for the passage of tension bolts. It can be clearly seen that this space is significantly larger in the region where the winding elements progress axially than in the region where the winding elements progress at an angle relative to the axial direction. The inventors of the present invention recognized that the use of bolts having small diameters can negatively affect the strength of rotor 1 in the region of the winding head.

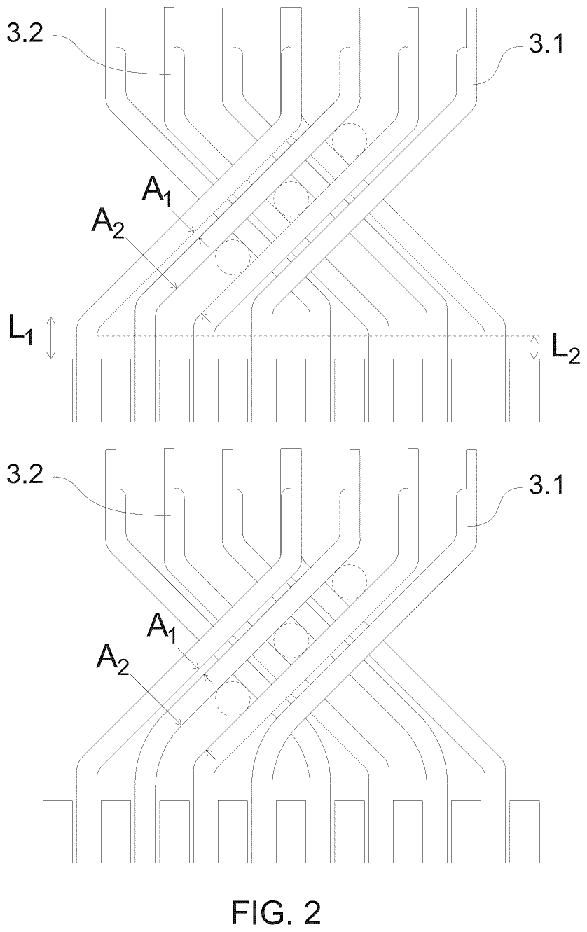

FIG. 2 shows an inventive rotor in two alternative embodiments in the same presentation format as in FIG. 1. In the case of the illustrated rotors, the winding elements—in the region in which they progress at an angle to the axial direction—are located at different distances A₁ and A₂ to the two adjacent winding elements in the same layer. This means that each winding element—in the region in which it progresses at an angle to the axial direction—is located at a distance of A₁ from a first directly adjacent winding element of the same layer, and at a distance A₂ from a second directly adjacent winding element of the same layer, wherein A₂ is greater than A₁. It is therein clear that each winding element has exactly two directly adjacent winding elements in the same layer. The distances are thereby eroded in a direction vertical to the surface between the winding elements (see FIG. 2). As can be seen from FIG. 2, this results in spaces in the area where the winding elements progress at an angle relative to the axial direction, which are suitable for accommodating tension bolts with a larger diameter.

The two embodiments illustrated in FIG. 2 achieve this in different ways. In the embodiment shown in the upper part of FIG. 2, the winding elements have different lengths L₁ and L₂, by which they respectively protrude from the rotor body in axial direction before they progress at an angle to the axial direction. In each layer, the winding elements alternate with length L₁ and length L₂. This allows a distinction to be made between two types or groups of winding elements with respect to the respective winding head. It is clear that the two groups each include half the winding elements. In FIG. 2, always one winding element of the two types, or respectively groups, is identified as 3.1 and 3.2.

In the embodiment shown in the lower part of FIG. 2, the winding elements have different radii of curvature R₁ and R₂, at which the winding elements turn from the axial direction to the direction progressing at an angle to the axis after emergence from the rotor body. Also in this case, two types, or respectively groups, of winding elements can be distinguished with regard to the respective winding head.

The additional embodiments are described below only for the version according to the upper part of FIG. 2. However, they can easily be implemented analogously for the version according to the lower part of FIG. 2.

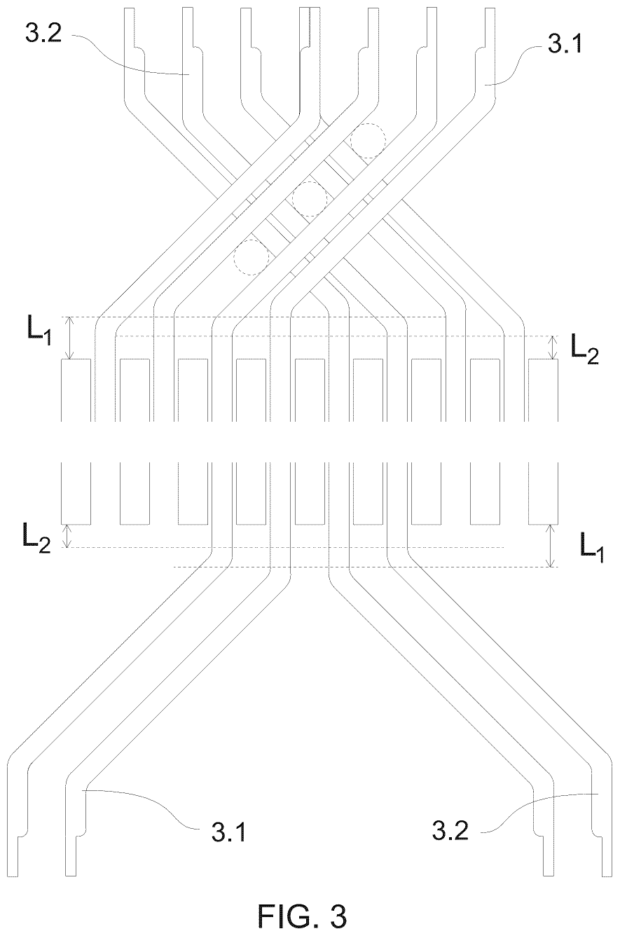

FIG. 3 shows an example of an embodiment according to the present invention with regard to a first possibility as to how the winding elements can continue in the opposite winding head. In the upper part of FIG. 3, the winding head is shown the same way as in FIG. 2. In the lower part of FIG. 3, the other winding head is shown, wherein for the sake of clarity, only four of the winding elements illustrated above are shown continuing below. In the illustrated embodiment, every winding element in both winding heads protrudes axially from the rotor body by the same length. This means that a winding element 3.1, which protrudes in one winding head axially from the rotor body by length L₁, also protrudes in the other winding head by length L₁. A winding element 3.2, which protrudes in one winding head axially from the rotor body by length L₂, also protrudes in the other winding head by length L₂. This results in that the two types of winding elements 3.1 and 3.2 are not only distinguishable from each other in regard to a winding head but are also each designed individually differently. Thus, two batches of different versions of winding elements must be produced.

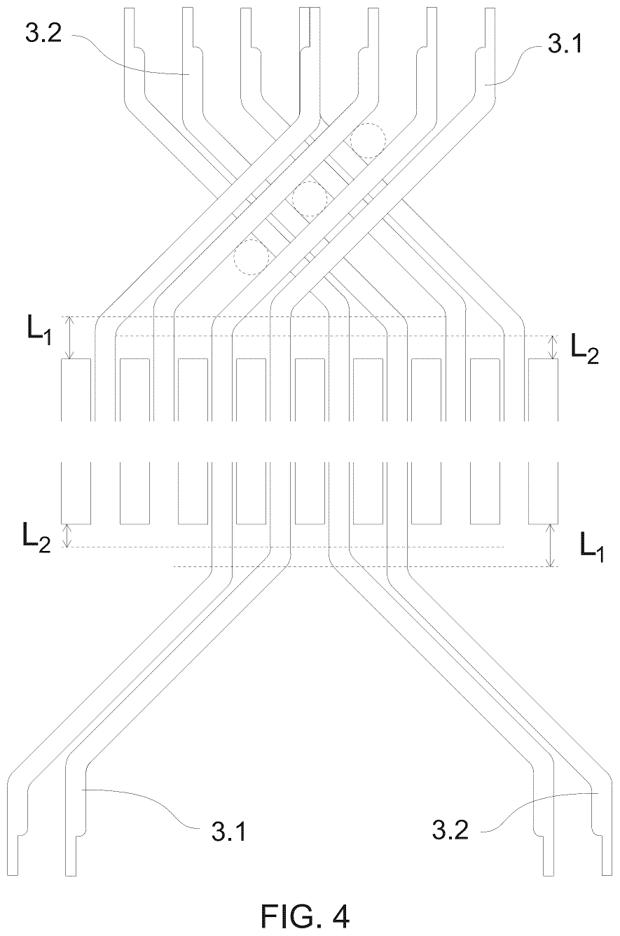

FIG. 4 shows an example of an embodiment according to the present invention, relating to a second possibility as to how the winding elements can continue in the opposite winding head. The manner of representation is analogous to FIG. 3. In the embodiment shown, each winding element in both winding heads protrudes axially from the rotor body by different lengths. This means that a winding element 3.1, which protrudes axially from the rotor body in one winding head by length L₁, protrudes in the other winding head by length L₂. And a winding element 3.2, which protrudes axially from the rotor body in one winding head by length L₂, protrudes in the other winding head by length L₁. As a result, the two types of winding elements 3.1 and 3.2 can only be distinguished from each other in separate consideration in relation to a winding head. They absolutely—that is before installation in the rotor—do not differ from each other, since—as can be seen from FIG. 4—each winding element 3.1 merges into a winding element 3.2 through a rotation of 180° perpendicular to the drawing plane. This means that the winding elements differ only in their installation position. Thus, a single batch of winding elements with an identical design can be produced.

It should be mentioned that the winding elements of the individual layers generally differ slightly from each other in terms of design. However, this is not recognizable in the drawings due to the form of representation. Strictly speaking, this means that the previous remarks apply only to the winding elements of one and the same layer.

In the following, additional advantageous embodiments of the present invention are described as regards the formation of the retaining elements with which the winding elements are held in the area of the winding head.

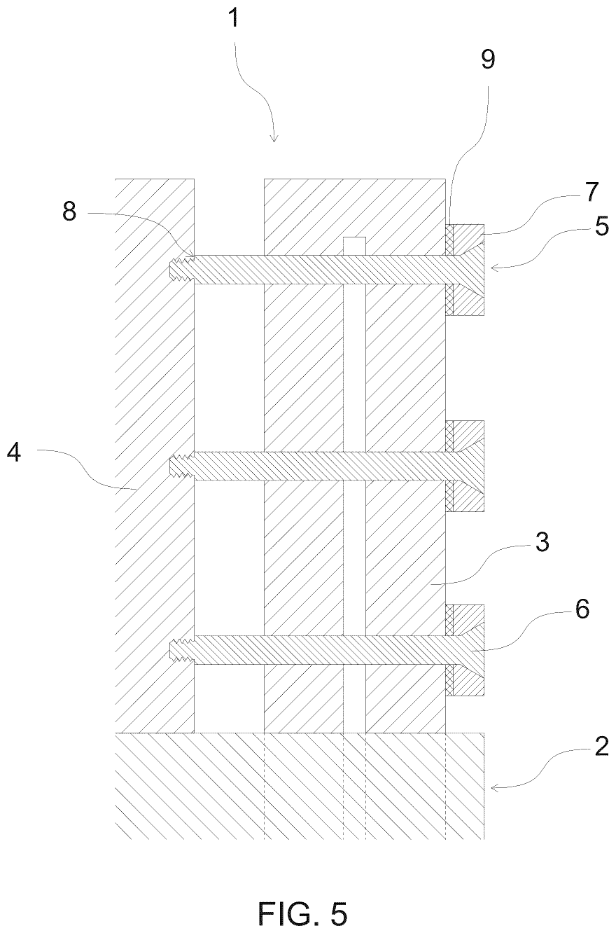

FIG. 5 is an illustration of a rotor according to the present invention in a schematic representation. FIG. 5 therein shows only a section of the rotor. The rotor is labeled 1. Rotor 1 includes a rotor body, which is identified as 2, and a multitude of winding elements, which are arranged in axially progressing grooves of rotor body 2. The winding elements form two layers in radial direction. The winding elements protrude in axial direction beyond rotor body 2 and thus form a so-called winding head, which is arranged axially adjacent to rotor body 2. In each case, a winding element of one layer is connected at its end with the end of a winding element of the other layer. In FIG. 5, a winding element is identified as 3.

So that the winding elements 3 are not bent radially outwards by the enormous centrifugal forces occurring during the operation of the electric machine, they must be held in position in the region of the winding head. For this purpose, the winding head includes a winding head support, which is identified as 4 in FIG. 5, and a large number of retaining elements, one of which is identified 5 in FIG. 5. Each retaining element 5 includes a tension bolt and a support body. In FIG. 5, one of the tension bolts is identified as 6 and one of the support bodies is identified as 7. Support bodies 7 are arranged in radial direction outside winding elements 3. Tension bolts 6 each penetrate corresponding support body 7 and are screwed into winding head support 4 by way of a thread. Winding head support 4 can also consist of several parts, so that tension bolts 6 are for example screwed into profile strips which are arranged in corresponding grooves of the winding head support body. Profile strips and winding head support bodies are then parts of winding head support 4.

It is advantageous if retaining elements 5 include a stop surface 8, which is designed in such a way that it can come into contact when screwing tension bolts 6 to winding head support 4, in order to adjust the radial length with which tension bolts 6 protrude from winding head support 4 to a predefined dimension. The predefined dimension is calculated so that support bodies 7 are not pressed against winding elements 3 in the resting position of rotor 1. This means that, in the resting position of rotor 1, support bodies 7 ideally just touch winding elements 3 when tension pull bolts 6 are screwed into winding head support 4 until stop surface 8 comes into contact with winding head support 4. Alternatively, there may also be a (small) space between support body 7 and winding elements 3 in the aforementioned position.

The characteristic “that support bodies 7 are not pressed against winding elements 3 in the resting position of rotor 1” is to be understood herein to mean that the compressive force transmitted to winding elements 3 by tightened tension bolts 6 in the resting position of rotor 1 is negligible compared to the tensile force acting in tightened tension bolts 6. This is the case if the compressive force transmitted to winding elements 3 by a tightened tension bolt 6 is less than 15% of the tensile force acting in respective tension bolt 6.

On the one hand, stop surfaces 8 designed in this way prevent winding elements 3 from being deformed when tension bolts 6 are screwed in. On the other hand, they ensure that the screw connection between tension bolt 6 and winding head support 4 is tensioned so that the screw connection cannot come loose during operation of rotor 1. High pre-tensioning of tension bolts 6 also means that the additional force acting on tension bolts 6 during operation is small compared to the pre-tensioning force, which extends the service life of tension bolts 6.

Optionally, retaining elements 5 may include an elastic element which is arranged in the space between associated support body 7 and winding elements 3 which are held by respective retaining element 5. In FIG. 5, such an elastic element is identified as 9. Elastic elements 9 are designed in such a way that they are pressed together slightly in radial direction when tension bolts 6 are screwed in until corresponding stop surfaces 8 come into contact with winding head support 4. The elasticity module of elastic elements 9 is therein to be selected herein in such a way that, when they are pressed together, no significant deformation of winding elements 3 can occur. In other words, elastic elements 9 are designed in such a way that no significant deformation of winding elements 3 can occur when tension bolts 6 are screwed in until the corresponding stop surfaces 8 come into contact with winding head support 4.

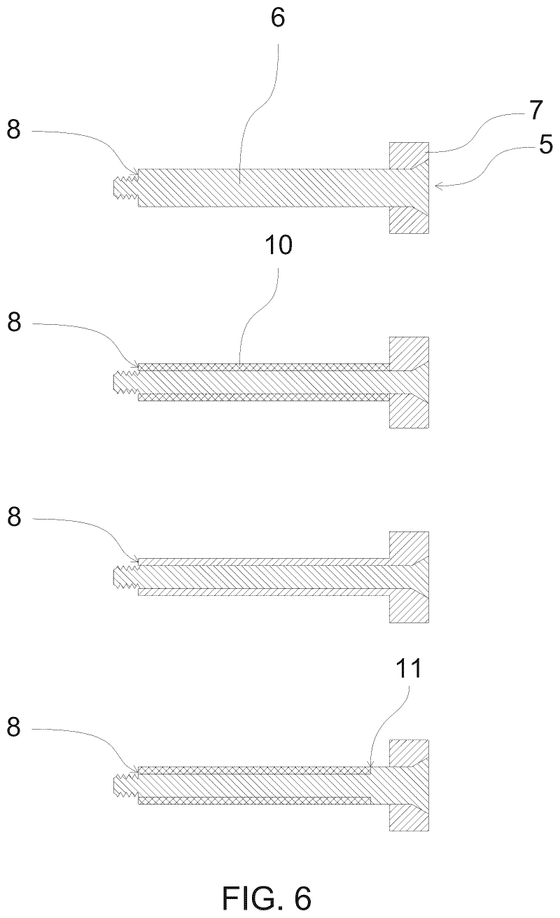

FIG. 6 shows various embodiments of inventive retaining elements 5. In the embodiment shown at the top, stop surface 8 is formed by a step of tension bolt 6. In the second embodiment shown second from the top, retaining element 5 includes a sleeve identified as 10. Tension bolt 6 penetrates sleeve 10 and stop surface 8 is formed by the end of sleeve 10, which is oriented towards winding head support 4. In the third embodiment show third from the top, support body 7 includes a sleeve-like protuberance, wherein stop surface 8 is arranged at the end of the protuberance. In the latter embodiment, support bodies 7 are only partially arranged in a radial direction outside of winding elements 3, since the sleeve-shaped protuberance of same extends between winding elements 3. This protuberance can also serve to support the winding elements which are retained by the respective retaining element in lateral direction. An additional embodiment results by combining the latter two embodiments, that is, by combining a shorter sleeve 10 with a correspondingly shorter protuberance of support body 7. Stop surface 8 is herein formed by the end of sleeve 10. In the lowest embodiment shown in FIG. 6, tension bolt 6 includes a step, which is identified as 11 and which presses against a sleeve 10 when being screwed in. Here too, stop surface 8 is provided by the end of sleeve 10. The advantage of this embodiment is that support body 7 is extensively relieved. Further embodiments result from the use of several sleeves 10 per tension bolt 6, whereby sleeves 10 are pressed against each other when screwing in associated tension bolt 6.

As can be seen from FIG. 6, retaining elements 5, which include a stop surface 8, thus have a larger diameter in the section with which they penetrate the winding head. Since a winding head according to the present invention also has enlarged openings in the area in which the winding elements progress at an angle to the axial direction compared to the known winding heads, retaining elements 5 according to FIG. 6 can also be used in this area. Alternatively, conventional retaining elements without stop surface 8 can also be used. The space gained thereby can be used for a larger diameter of tension bolts 6.

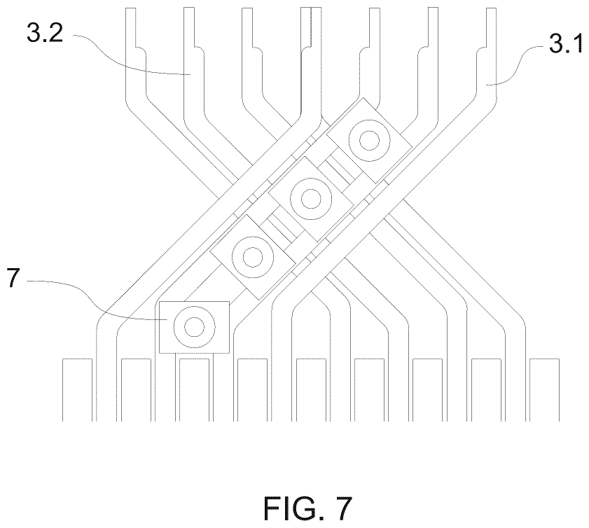

In FIG. 7 a rotor according to the present invention is shown according to the embodiment in the upper part of FIG. 2, wherein the position of support bodies 7 is shown in the two different areas of the winding head. At least a part of the tension bolts penetrates the winding head in radial direction in the area where the winding elements progress at an angle to the axial direction.

### COMPONENT REFERENCE LISTING

1 Rotor
2 Rotor body
3 Winding element
3.1 Winding element
3.2 Winding element
4 Winding head support
5 Retaining element
6 Tension bolts
7 Support body
8 Stop surface
9 Elastic element
10 Sleeve
11 Step

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A rotor for an electric machine, the rotor comprising:
a rotor body, which includes a plurality of axially progressing grooves;
a plurality of winding elements, the plurality of winding elements being arranged in the plurality of axially progressing grooves of the rotor body in two layers; and
a winding head arranged axially adjacent to the rotor body, the winding head including two regions including a first region and a second region, in the first region the plurality of winding elements progressing in an axial direction, in the second region the plurality of winding elements progressing at an angle to the axial direction, the winding head including a winding head support and a plurality of retaining elements, each of the plurality of retaining elements respectively including a tension bolt and a support body, the support body being arranged at least partially in a radial direction outside of the plurality of winding elements, each of the tension bolt respectively penetrating the support body—which is associated therewith—and is screwed into the winding head support by way of a thread, wherein at least a part of the tension bolt penetrating the winding head in the radial direction in the second region, wherein each respective one of the plurality of winding elements in the second region—in which each respective one of the plurality of winding elements progresses at the angle to the axial direction—being located at a distance A₁ from a first directly adjacent one of the plurality of winding elements of a same one of the two layers and at a distance A₂ from a second directly adjacent one of the plurality of winding elements of a same one of the two layers, A₂ being greater than A₁.

2. The rotor according to claim 1, wherein half of the plurality of winding elements forms a first group, wherein another half of the plurality of winding elements forms a second group, wherein the plurality of winding elements of the first group protrude by a length L₁ from the rotor body in the axial direction before the plurality of winding elements of the first group progress at an angle to the axial direction, wherein the plurality of winding elements of the second group protrude by a length L₂ from the rotor body in the axial direction before the plurality of winding elements of the second group progress at an angle to the axial direction, and wherein L₁ is greater than L₂.

3. The rotor according to claim 1, wherein half of the plurality of winding elements forms a first group, wherein another half of the plurality of winding elements forms a second group, wherein the plurality of winding elements of the first group have a radius of curvature R₁ at which the plurality of winding elements of the first group turn from the axial direction to a direction progressing at an angle to an axis of the rotor after emergence from the rotor body, wherein the plurality of winding elements of the second group have a radius of curvature R₂ at which the plurality of winding elements of the second group turn from the axial direction to a direction progressing at an angle to an axis of the rotor after emergence from the rotor body, and wherein R₁ is greater than R₂.

4. The rotor according to claim 3, wherein, with respect to one of the two layers, the plurality of winding elements of the first group and the plurality of winding elements of the second group differ in configuration.

5. The rotor according to claim 3, wherein, with respect to one of the two layers, the plurality of winding elements of the first group and the plurality of winding elements of the second group do not differ in configuration.

6. The rotor according to claim 1, wherein the plurality of retaining elements respectively include a stop surface, which is configured for coming into contact with the winding head support when screwing in the tension bolt, in order to thereby adjust the radial length with which the tension bolt protrudes from the winding head support to a predefined dimension, wherein the predefined dimension is calculated so that the support body is not pressed against the plurality of winding elements in a resting position of the rotor.

7. The rotor according to claim 6, wherein a respective one of the plurality of retaining elements includes an elastic element which is arranged in a space between the support body and the plurality of winding elements—associated with the elastic element—which are held by the respective one of the plurality of retaining elements.

8. The rotor according to claim 6, wherein the tension bolt includes a step, wherein the stop surface is formed by the step of the tension bolt.

9. The rotor according to claim 8, wherein the tension bolt includes a step which is configured for being pressed against the sleeve when the tension bolt is tightened.

10. The rotor according to claim 6, wherein a respective one of the plurality of retaining elements includes a sleeve which includes an end, wherein the tension bolt penetrates the sleeve, wherein the stop surface is formed by the end of the sleeve, which is oriented towards the winding head support.

11. The rotor according to claim 6, wherein the support body includes a protuberance which is sleeve-like and includes an end, wherein the stop surface is arranged at the end of the protuberance.
